(19) United States
(12) Patent Application Publication
(10) Pub. No.: US 2007/0208547 A1
(43) Pub. Date: Sep. 6, 2007

(54) Numerical Modeling Process and System of Singular Vector Physical Quantities and Corresponding Software Product

(76) Inventors: Roberto D Graglia, Torino (IT); Guido Lombardi, Montevarchi (IT)

Correspondence Address: BERKELEY LAW & TECHNOLOGY GROUP, LLP, 17933 NW Evergreen Parkway, Suite 250, BEAVERTON, OR, 97006, US

(21) Appl. No.: 10/570,922

(22) PCT Filed: Sep. 2, 2004
(86) PCT No.: PCT/IB04/02856

§ 371 Date: Mar. 6, 2007

(30) Foreign Application Priority Data
Sep. 5, 2003 (IT) TO2003000675

(51) Int. Cl. G06F 17/00

(52) U.S. Cl. 703/2

(57) ABSTRACT

Numerical process to model singular vector physical quantities associated to at least a body (E), with possible local singular behavior of the physical quantities that may assume unlimited values in the singularity region. According to this invention this process is characterized by the following operations: to scan (10) the geometry of the singularity region and to plot it with a reference frame; to subdivide the singularity region into two dimensional domains, usually curvilinear; and; to describe with reference to these domains the properties of at least a physical quantity directly in the parent domain, deriving the singular curl conforming basis functions and the singular divergence conforming basis functions for meshed domains with (T, TE, TV) triangles and (Q) quadrilaterals, usually curvilinear. Besides this process allows for the definition of particular set of singular basis functions for FEM and MoM applications.

### FIELD OF THE INVENTION

This invention concerns numerical modeling techniques of vector physical quantities, for instance force fields, electric and electromagnetic fields, fields of currents, capable to locally behave as singular quantities. The singular behavior may be found usually near material and/or geometrical sharp discontinuities as sharp edges, fractures, edges of wings or wedges, vertices and similar structures. The singularity of physical quantities implies that these are unlimited in the singular region. These values are at worst infinite in the extremity or extremities of the singular region. The singular behavior of physical quantities can be observed particularly near the singular region.

In the singular region the energy is localized and remains finite even if the physical quantities have singular behavior, i.e. have infinite values. These numerical modeling techniques are developed with particular attention to the possible software applications: accurate analysis and design of structures with singular physical quantities of different nature. In electromagnetics the accurate study of fields and currents in structures with wedges, edges, vertices, tips and similar structures has several applications: EMC (ElectroMagnetic Compatibility), EMI (ElectroMagnetic Interference) and radar applications of different complex structures. These techniques are used in the analysis of properties (such as losses, reflections and transmissions) of passive electromagnetic devices (modal filters, Ortho-mode Transducer . . . ) and others.

The candidate softwares to use this process use numerical methods known in literature with the adjective of “finite” (Finite Methods).

### BACKGROUND OF THE INVENTION

Commercial codes and the most advanced research codes model the unknowns of the problem (vector physical quantities) using expansion functions (basis functions) that are vector polynomial functions, defined on subdomains. The physical problem is formulated through partial differential equations or integral equations and it is discretized numerically. In order to model the possible singularities of physical quantities, in particular fields, the most advanced commercial codes discretize the singular regions with subdomains of extremely reduced dimension. This technique partially improves the convergence properties of the solution with increasing computational cost. Subdomains of “reduced” dimensions are used in the singular regions because it is not suitable to increase the polynomial order of the expansion functions to improve the precision of solution. Other techniques use hierarchical expansion functions which however do not imply the convergence of solution because of their polynomial nature.

In fact, the singularities must be modeled by functions having exponent of negative fractional order (irrational algebraic functions); therefore it is not possible to correctly model this behavior by the use of polynomial functions with integer exponents.

In order to increase the efficiency of numerical codes and to increase the solution precision in presence of singularities it is necessary to define basis functions which incorporate the physical behavior near the geometrical and/or material singularities.

In electromagnetics, basis functions of non polynomial kind have been introduced, however the results have not been satisfactory because all the proposed functions show defects and modeling errors.

Numerical methods using subsectional higher-order vector bases are nowadays able to compute physical quantities in very complex electromagnetic structures without excessive computational cost except for structures with “singular” geometries.

The Finite Element Method (FEM) can be used to discretize partial differential models with isotropic or anisotropic inhomogeneous media.

Furthermore in FEM applications the use of higher-order vector expansion functions of curl conforming kind has increased the computational precision of solutions, and it has removed numerical problems known in literature—see for instance the following paper R. D. Graglia, D. R. Wilton and A. F. Peterson, “Higher order interpolatory vector bases for computational electromagnetics,” special issue on “Advanced Numerical Techniques in Electromagnetics” IEEE Trans. Antennas Propagat., vol. 45, no. 3, pp. 329-342, March 1997—as spurious nonphysical modes or spurious solutions.

In a similar way, the Method of Moments (MoM) can be applied to discretize integral equations using higher-order vector expansion functions of divergence conforming kind.

Numberless structures of practical engineering interest contain edges, wedges, vertices, tips or similar structures constituted by penetrable or impenetrable media. Near these discontinuities the physical quantities can be singular of irrational algebraic kind, as shown for example in the following publications J. Van Bladel, Singular Electromagnetic Fields and Sources Oxford: Clarendon Press, pp. 116-162, 1991 e J. Meixner, “The behavior of electromagnetic fields at edges,” IEEE Trans. Antennas Propagat., vol. AP-20, no. 4, pp. 442-446, July 1972.

Since the singular behavior is dominant near these discontinuities, the numerical analysis of these structures uses meshes which are locally very dense and therefore very expensive under the computational point of view.

In general, it is not granted that iterative mesh refinement could provide good effective solutions to these problems, whereas iterative mesh refinement involves complex processes and codes, increases the computational time and uses extra memory.

The literature shows that iterative mesh refinement is widely used in the FEM context, whereas it can hardly be considered by MoM practitioners since one would have to recompute too many coefficients of MoM matrices for each step of refinement.

The best alternative to heavy mesh refinement or to using very dense meshes is the introduction of singular functions able to precisely model the singular edge behavior of physical quantities.

Even by increasing the polynomial order of regular bases one is not certain to obtain the full convergence of numerical solution.

In the course of this description we refer to an electromagnetic context, but the proposed process can be extended to problems of different nature where the physical unknown is of vector kind and the problem is described by PDE (Partial Differential-Equations) or IE (Integral-Equations) as it happens in acoustic and mechanical problems.

The following paper presents specific functions for FEM applications able to model numerically singular electromagnetic fields: J. M. Gil, and J. P. Webb, “A new edge element for the modeling of field singularities in transmission lines and waveguides,” IEEE Trans. Microwave Theory and Tech., vol. 45, n. 12, Part 1, pp. 2125-2130, December 1997.

However that process uses a triangular polar reference frame in order to define the basis functions, which implies an increase of computational cost in numerical codes and difficulties to deal with curvilinear subdomains (curvilinear elements). Moreover the proposed functions are six for the transverse component and six for the longitudinal component, thus they are compatible with adjacent regular elements of order one. That proposed element is not of the lowest order (zeroth order). Besides no process to build higher order singular elements is described.

Finally the functions, proposed in that paper, do not vanish when the singularity coefficient v is equal to 1 and they have a non physical exploding behavior in the limit for v→1 (longitudinal component). The process is based on triangular elements and does not show a detailed physical analysis of the problem: the functions are not subdivided in the static component (potential functions) and dynamic component.

Even the following paper Z. Pantic-Tanner, J. S. Savage, D. R. Tanner, and A. F. Peterson, “Two-dimensional singular vector elements for finite-element analysis,” IEEE Trans. Microwave Theory Tech., vol. 46, pp. 178-184, February 1998, uses a triangular polar reference frame to define singular basis functions. In this paper the proposed functions are eight for the transverse component. They are more than what is necessary to define a singular lowest order element compatible with an adjacent regular element of order zero. The behavior of the longitudinal component is not considered. Even in this case no detailed analysis of the physics is present, and the functions are not subdivided in the static component (potential functions) and dynamic component, and furthermore the proposed elements are triangular and no process to define higher order elements is presented.

The literature contains processes which define basis functions able to deal with surface current densities in MoM applications.

In particular the paper by W. J. Brown and D. R. Wilton, “Singular basis functions and curvilinear triangles in the solution of the electric field integral equation,” IEEE Trans. Antennas Propagat., vol. 47, n. 2, pp. 347-353, February 1999, proposes a process based on triangular elements. This process is not additive and the proposed functions are of non-substitutive kind, i.e. when v is 1, one obtains regular basis functions of divergence conforming kind.

Furthermore, this publication does not describe any technique to define higher order elements.

### OBJECTS AND SYNTHESIS OF THE INVENTION

The invention realizes a solution able to solve the drawbacks of the known solutions previously described, and it defines basis functions which incorporate the physical behavior near the geometrical and/or material singularities and that include the physical properties of the problem.

With reference to this invention, the aim is obtained with a process described precisely in the claims that follow.

This invention also concerns the system, as well as the corresponding software loadable into the memory of a numeric machine, as for example a processor, with specific software instructions to implement the process described in this invention.

Substantially the proposed solution consists of a numerical modeling process of vector physical quantities associated to at least a body with possible local singular behavior. The process defines higher-order vector singular functions, curl and divergence conforming, on two dimensional curvilinear subdomains. The proposed basis functions are directly defined in the parent domain without introducing any intermediate reference frame (R. D. Graglia, D. R. Wilton and A. F. Peterson, “Higher order interpolatory vector bases for computational electromagnetics,” special issue on “Advanced Numerical Techniques in Electromagnetics” IEEE Trans. Antennas Propagat., vol. 45, no. 3, pp. 329-342, March 1997).

In electromagnetic problems, the proposed basis functions incorporate the singular requirements and are able to approximate the unknowns near the singularity for each value of the singularity coefficient v. For curl conforming functions (FEM case), the wedge can be penetrable. On the contrary the wedge is supposed impenetrable for divergence conforming functions (MoM case).

The curl conforming functions and the divergence conforming functions are compatible with standard higher order vector regular elements (polynomial kind) (R. D. Graglia, D. R. Wilton and A. F. Peterson, “Higher order interpolatory vector bases for computational electromagnetics,” special issue on “Advanced Numerical Techniques in Electromagnetics” IEEE Trans. Antennas Propagat., vol. 45, no. 3, pp. 329-342, March 1997).

Compared to the known solutions, this new technique eliminates defects and modeling errors completely following the physics of the problem.

### SHORT DESCRIPTION OF THE DRAWING FIGURES

In this section the invention will be described without loss of generality by referring to the enclosed figures:

FIG. 1 shows a schematic drawing of the discretization process and the modeling process for a curvilinear wedge with curl conforming singular elements according to the invention;

FIG. 2 shows a schematic drawing of the discretization process and the modeling process for a curvilinear wedge with divergence conforming singular elements according to the invention;

FIGS. 3 to 6 show test diagrams of the modeling process according to the invention on a circular waveguide with septum (“vaned waveguide”);

FIGS. 7 and 8 show test diagrams of the modeling process according to the invention on a circular waveguide with double septum of non zero thickness;

FIG. 9 shows a system which implements the modeling process according to the invention;

FIG. 10 shows a productive example of the system described in FIG. 9.

### SPECIFIC DESCRIPTION OF PRODUCTIVE EXAMPLES OF THE INVENTION

Here is recalled the fundamental theory related to the invention as introduction to the detailed description of the productive examples. In electromagnetics the discretization of the current is required by the MoM solution of surface integral equations; conversely, discretization of the electric (E) or of the magnetic as field is required by FEM approaches.

It is important to notice that geometric and material discontinuities such as wedges naturally yields to two dimensional problems, because the edge can be considered locally rectilinear.

In order to deal with singularities of physical quantities it is necessary to subdivide the models into the following two categories:
PDE (Partial Differential Equations), that require curl conforming basis functions (wave equation for electromagnetic fields in closed and open structures . . . );
IE (Integral Equations), that require divergence conforming basis functions (fields of current in diffraction problems, antenna problems . . . ).

Let us consider for a moment a generic electromagnetic problem at angular frequency ω where the wedge E of aperture angle α is immersed in free space.

The wedge can be penetrable for curl conforming functions (PDE case, FEM), while the wedge can only be impenetrable for divergence conforming functions (IE case, MoM).

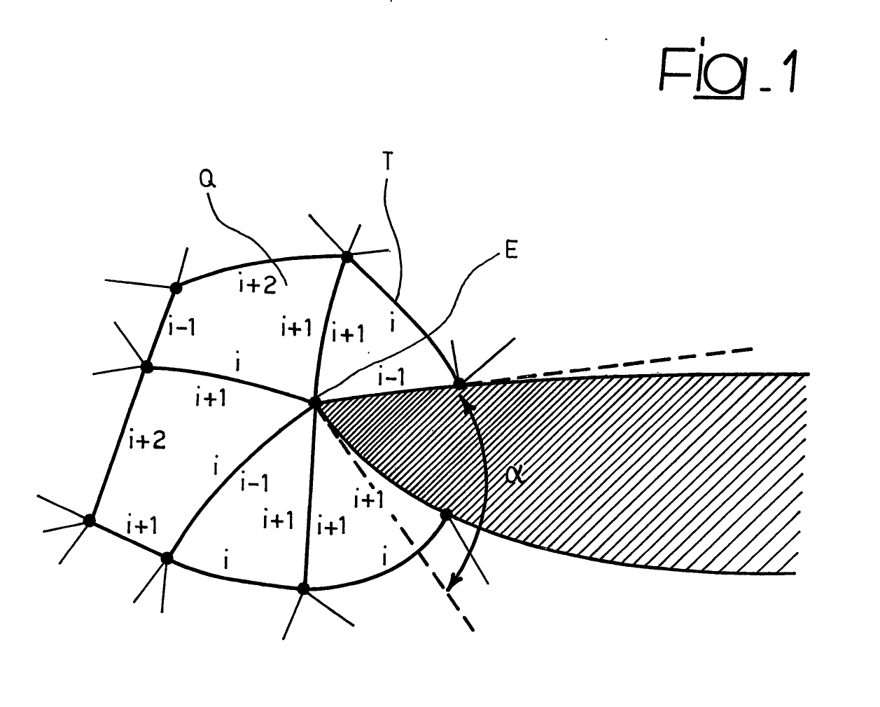

FIG. 1, FEM case, shows for this purpose a section of curvilinear wedge region E with aperture angle α. The mesh, i.e. the discretization into subdomains, is constituted by triangular and quadrilateral curvilinear elements of “curl conforming” kind. The singular triangular elements are labeled with T while the quadrilateral singular elements are labeled with Q; they are attached to the vertex of wedge E which is extended longitudinally. The edges of T or Q elements are locally numbered counter-clockwise from i−1 to i+1 for triangular elements T and from i−1 to i+2 for quadrilateral elements Q. For each T element the i-th edge is opposite to the sharp-edge vertex and for each Q element the i-th edge and the (i+1)th edge are connected to the sharp-edge vertex.

By introducing a polar reference frame with origin at the edge of the wedge E the electromagnetic quantities assume the following form (impenetrable conducting wedge):

$${J}_{s} = \frac{vA}{{ρ}^{1 - v}} \hat{z} + j ω {ɛ}_{0} B {ρ}^{v} \hat{ρ} \\ \{ \begin{matrix}{E}_{z} = j ω {μ}_{0} A {ρ}^{v} sin v ϕ \\ {H}_{t} = \frac{vA}{{p}^{1 - v}} ( sin v ϕ \hat{ϕ} - cos v ϕ \hat{ρ} )\end{matrix} \\ \{ \begin{matrix}{H}_{z} = j ω {ɛ}_{0} B {p}^{u} cos v ϕ + constant \\ {E}_{t} = - \frac{vB}{{p}^{1 - v}} ( cos v ϕ \hat{ϕ} + sin v ϕ \hat{p} )\end{matrix} \qquad ( 1 )$$

For penetrable wedge, the singularity coefficient v depends on the material as well as on the geometry, i.e. the aperture angle of the wedge E (J. Van Bladel, Singular Electromagnetic Fields and Sources Oxford: Clarendon Press, pp. 116-162, 1991). The singularity coefficient v is usually evaluated for the static case, because the singularity coefficient is frequency independent.

The proposed numerical modeling process of physical quantities associated to a body concerns the description of the properties for T or Q elements directly defined on the parent domain, and the definition of singular curl and divergence conforming basis functions for domains which are discretized by T and Q elements.

The process defines systematically higher order potentials to model the static component of the curl conforming bases.

Besides the process defines higher order functions of edge-less kind to model the dynamic component of the curl conforming bases.

Furthermore the process concerns the definition of divergence conforming bases for T and Q elements. The T element is subdivided into two kinds depending in its being a filling element or not.

Besides the process concerns the definition of the minimum number of curl conforming basis functions and the minimum number of divergence conforming basis functions able to model the singular behavior, therefore it determines the correct number of degrees of freedom in accordance to the chosen polynomial order of the bases.

Besides the process defines the set of properties that the basis functions have to follow in order to model correctly the problem described by PDEs or IEs.

Besides the process describes a process to implement singular bases inside FEM and MoM codes.

Now we distinguish different cases:
functions for FEM applications that model singular electromagnetic fields;
functions for MoM applications that model singular surface current densities.

For FEM applications, where the basis functions model the electromagnetic fields, the proposed modeling process concerns that a lowest order singular curl conforming complete base must fulfill the following requirements:
the basis set and its curl must be complete just to the lowest order (zeroth order);
the T and Q elements must be fully compatible to adjacent regular elements of the same regular order attached to their nonsingular edges;
the basis functions must model the static ρ^{v-1} singular behavior;
the basis functions must model the non singular field whose curl behaves as ρ^{v} towards the edge of the wedge E;

The first requirement has been introduced not to limit the mesh dimensions of the T and Q elements near the wedge E, besides this requirement imposes that the lowest order set of functions must contain all the zeroth-order regular basis functions.

The second requirement is necessary to remove spurious numerical solutions.

The third requirement together with the previous ones imposes that the singular basis functions must be added to the regular subset to build a complete base; besides the singular functions can not be of interpolatory form because they must model a local singular behavior (with negative fractional exponent) which depends on the energy properties of the field.

The third and the fourth requirement allow for the correct physical modeling of the problem according to the behavior described previously in the cited publications by Van Bladel and Meixner.

In particular the third requirement shows that the singular behavior of the field is well modeled by a static component (zero curl), therefore by a gradient of a scalar potential function. Besides this potential models correctly the longitudinal components of the field.

The fourth requirement describes the dynamic behavior of the field (curl with ρ^{v} behavior) that can be modeled by functions that, according to this process, are of edge-less kind because these functions must model the field curl and not the field itself; besides these functions do not pose any problem to the compatibility and to the conformity with adjacent regular elements.

According to this process, to model the transverse field in the neighborhood of a sharp edge E we derive singular basis functions as the gradient of scalar potential and from the behavior of the curl.

These functions must fulfill the following requirements:
they vanish for v=1
they are identically equal to zero on all the element edges i, except for the one attached to the sharp-edge E: this requirement guarantees that the gradient of each potential is exactly normal to the element edges where the potential is zero
the potentials are constructed so to guarantee the correct singular tangent component of their gradient along the edge where the potential is not zero.

We propose a definition of the potential functions of lowest order as follows:

T triangular element
φ_{i±1}(r)=ξ_{i∓1}[1−(1−ξᵢ)^{v-1}] (2)

Q quadrilateral element:
φᵢ(r)=ξᵢ₊₂(ξⱼ−ξⱼ^{v})
φⱼ(r)=ξⱼ₊₂(ξᵢ−ξᵢ^{v}) (3)

By using Silvester interpolatory polynomial of order s α_{abc}^{t}(s,ξ) (R. D. Graglia, D. R. Wilton and A. F. Peterson, “Higher order interpolatory vector bases for computational electromagnetics,” special issue on “Advanced Numerical Techniques in Electromagnetics” IEEE Trans. Antennas Propagat., vol. 45, no. 3, pp. 329-342, March 1997) or by using any other complete set of polynomials it is possible to define potential functions of higher order s as follows:

T triangular element:
φ_{abc}^{i±1}(r)=α_{abc}^{i±1}(s,ξ)φ_{i±1}(r) (4)

Q quadrilateral element:
φ_{ac;bd}ⁱ(r)=α_{ac;bd}ⁱ(s,ξ)φᵢ(r),
φ_{ac;bd}ⁱ⁺¹(r)=α_{ac;bd}ⁱ⁺¹(s,ξ)φᵢ₊₁(r) (5)

To model the transverse component of the triangular element T the lowest order singular curl conforming bases contain the regular zeroth order functions, the gradient of potentials and the edge-less functions reported in table 1 as follows:

TABLE 1
LOWEST-ORDER CURL-CONFORMING BASES.
Triangular Bases, with subscripts counted modulo 3, and i = 1, 2 or 3

| Basis Functions | Surface Curls |
|---|---|
| Regular Functions | |
| $\begin{matrix}{Ω}_{β } ( r ) = {ξ}_{β + 1} ∇ {ξ}_{β - 1} - {ξ}_{β - 1} ∇ {ξ}_{β + 1} \\ for β = i , i \pm 1\end{matrix}$ | $\begin{matrix}∇ \times {Ω}_{β } ( r ) = 2 \hat{n} / 𝒥 \\ for β = i , i \pm 1\end{matrix}$ |
| Wedge Functions | |
| $\begin{matrix}{}_{}^{0}{Ω}{}_{i \pm 1}^{} ( r ) = ∇ [ {ξ}_{i ∓ 1} ( 1 - {χ}^{ν - 1} ) ] \\ {}_{}^{ν}{℧}{}_{i}^{} ( r ) = ( 1 - ν ) ( {χ}^{ν} - 1 ) {Ω}_{i} ( r ) \\ with χ = 1 - {ξ}_{i}\end{matrix}$ | $\begin{matrix}∇ \times {}_{}^{0}{Ω}{}_{i \pm 1}^{} ( r ) = 0 \\ ∇ \times {}_{}^{ν}{℧}{}_{i}^{} ( r ) = ( 1 - ν ) \frac{[ ( 2 + ν ) {χ}^{ν} - 2 ]}{𝒥} \hat{n} \\ with χ = 1 - {ξ}_{i}\end{matrix}$ |

The properties of functions in table 1 for triangular element T are:
complete to the lowest order (the functions and their curl) as the following linear combinations describe

$${}_{}^{0}{Ω}{}_{i + 1}^{} ( r ) + {Ω}_{i + 1} ( r ) + {}_{}^{0}{Ω}{}_{i - 1}^{} ( r ) + {Ω}_{i - 1} ( r ) = {v ( 1 - {ξ}_{i} )}^{v - 1} ∇ {ξ}_{i} \\ ∇ ⨯ [ {}_{}^{v}{℧}{}_{i}^{} ( r ) + ( 1 - v ) {Ω}_{i} ( r ) ] = ( 1 - v ) \frac{( 2 + v ) {( 1 - {ξ}_{i} )}^{v}}{𝒥} \hat{n} \qquad ( 6 )$$
curl conforming
dependence relation for higher order sets according to:
   ∇[ξᵢ₊₁φᵢ₊₁(r)−ξᵢ₋₁φᵢ₋₁(r)]=0 (7)
higher order: the above scheme is defined as order [p,s]=[0,0] (lowest).

The higher order set of functions with general order [p,s] is the following one:

$$\{ \begin{matrix}{}_{}^{v}{℧}{}_{abc}^{i} ( r ) = {α}_{abc}^{i} ( s , ξ ) {}_{}^{v}{℧}{}_{i}^{} ( r ) & \\ {}_{}^{0}{Ω}{}_{abc}^{i + 1} ( r ) = {α}_{abc}^{i + 1} ( s , ξ ) {}_{}^{0}{Ω}{}_{i + 1}^{} ( r ) + {ϕ}_{i + 1} ( r ) ∇ {α}_{abc}^{i + 1} ( s , ξ ) & \{ \begin{matrix}{Ω}_{abc}^{i} ( r ) = {α}_{abc}^{i} ( p , ξ ) {Ω}_{i} ( r ) \\ {Ω}_{abc}^{i + 1} ( r ) = {α}_{abc}^{i + 1} ( p , ξ ) {Ω}_{i + 1} ( r ) \\ {Ω}_{abc}^{i - 1} ( r ) = {α}_{abc}^{i - 1} ( p , ξ ) {Ω}_{i - 1} ( r )\end{matrix} \\ {}_{}^{0}{Ω}{}_{abc}^{i - 1} ( r ) = {α}_{abc}^{i + 1} ( s , ξ ) {}_{}^{0}{Ω}{}_{i - 1}^{} ( r ) + {ϕ}_{i - 1} ( r ) ∇ {α}_{abc}^{i - 1} ( s , ξ ) & \end{matrix} \qquad ( 8 )$$

number of degrees of freedom for the order [p,s]: the total number of degrees of freedom for the regular subset is (p+1)(p+3) which is added to the number of degrees of freedom of the singular subset:
one singular component times (s+1) for 2 edges=2(s+1)
one singular component times s(s+1)/2 for each face=s(s+1)/2
one edge-less component times (s+1)(s+2)/2 for each face=(s+1)(s+2)/2 for a total of (p+1)(p+3)+(s+1)(s+3) degrees of freedom.

To model the transverse component of the quadrilateral element Q the lowest order singular curl conforming bases contain the regular zeroth order functions Ω_{β}(r), the gradient of quadrilateral potentials ⁰Ωᵢ(r), ⁰Ωⱼ(r) and the ^{v}υ_{β}(r) edge-less functions as reported in table 2.

The properties of functions for quadrilateral element Q are:
complete to the lowest order (the functions and their curl) as the following relation describes

$$∇ ⨯ [ {}_{}^{v}{℧}{}_{β}^{} ( r ) + ( 1 - v ) {Ω}_{β} ( r ) ] = ( 1 - v ) ( 1 + v ) {ξ}_{β + 2}^{v} \frac{\hat{n}}{𝒥} , β = i , j \qquad ( 9 )$$
curl conforming
dependence relation: higher order functions are independent.
higher order: the above scheme is defined as order [p,s]=[0,0] (lowest).

The higher order set of functions with general order [p,s] is the following one:

$$\{ \begin{matrix}{}_{}^{v}{℧}{}_{a c ; bd}^{β} ( r ) & = {α}_{a c ; bd}^{β} ( s , ξ ) {}_{}^{v}{℧}{}_{β}^{} ( r ) \\ {}_{}^{0}{Ω}{}_{a c ; bd}^{β} ( r ) & = ∇ [ {α}_{a c ; bd}^{β} ( s , ξ ) {ϕ}_{β} ( r ) ] = \\ & = {α}_{a c ; bd}^{β} ( s , ξ ) {}_{}^{0}{Ω}{}_{β}^{} ( r ) + {ϕ}_{β} ( r ) ∇ {α}_{a c ; bd}^{β} ( s , ξ ) \\ β = i , i + 1\end{matrix} \qquad ( 10 )$$

number of degrees of freedom for the order [p,s]: the total number of degrees of freedom for the regular subset is 2(p+1)(p+2) which is added to the number of degrees of freedom of the singular subset:
one singular component times (s+1) for 2 edges=2(s+1)
one singular component times s(s+1) for each face=2s(s+1)
two edge-less components times (s+1)ˆ2 for each face=2(s+1)ˆ2

for a total of 2(p+1)(p+2)+4(s+1)ˆ2 degrees of freedom.

TABLE 2
LOWEST-ORDER CURL-CONFORMING BASES.
Quadrilateral Bases, with subscripts counted modulo 4, and i = 1, 2, 3 or 4

| Basis Functions | Surface Curls |
|---|---|
| Regular Functions | |
| $\begin{matrix}{Ω}_{β } ( r ) = {ξ}_{β + 2} ∇ {ξ}_{β - 1} \\ for β = i , i + 2 , i \pm 1\end{matrix}$ | $\begin{matrix}∇ \times {Ω}_{β } ( r ) = \frac{\hat{n}}{𝒥} \\ for β = i , i \pm 2 , i \pm 1\end{matrix}$ |
| Wedge Functions | |
| $\begin{matrix}{}^{0} {Ω}_{i} ( r ) = ( {ξ}_{j}^{ν} - {ξ}_{j} ) ∇ {ξ}_{i} + ( {νξ}_{j}^{ν - 1} - 1 ) {Ω}_{i} ( r ) \\ {}^{0} {Ω}_{j} ( r ) = ( {ξ}_{i}^{ν} - {ξ}_{i} ) ∇ {ξ}_{j} + ( {νξ}_{i}^{ν - 1} - 1 ) {Ω}_{j} ( r ) \\ {}^{ν} {Ω}_{β} ( r ) = ( 1 - ν ) ( {ξ}_{β + 2}^{ν} - 1 ) {Ω}_{β} ( r ) , β = i , j with j = i + 1\end{matrix}$ | $\begin{matrix}∇ \times {}_{}^{0}{Ω}{}_{β}^{} ( r ) = 0 \\ ∇ \times {}_{}^{ν}{℧}{}_{β}^{} ( r ) = ( 1 - ν ) \frac{[ ( 1 + ν ) {ξ}_{β + 2}^{ν} - 1 ]}{𝒥} \hat{n} \\ for β = i , j and with j = i + 1\end{matrix}$ |

The longitudinal component of the triangular element T and the quadrilateral element Q in FEM applications are modeled by particular scalar basis functions. The scalar basis functions for singular structures (wedges) are obtained by the union of two basis subsets. The first set is the regular subset formed by, for example, Lagrange-Silvester polynomials, while the second subset is the singular one formed by the sharp-edge potential bases of order s given previously. These functions have the correct physical behavior, i.e. they vanish as ρ^{v} towards the edge of the wedge.

For order [p,s] the total number of degrees of freedom is:

T triangular element=[(p+2)(p+3)+(s+1)(s+3)]/2;

Q quadrilateral element=(p+2)ˆ2+2(s+1)ˆ2.

We describe, now, the proposed modeling process to define functions for MoM applications that model singular surface current densities.

A lowest order singular divergence conforming complete base, according to the proposed process, must fulfill completely the following requirements:
the basis set and its divergence must be complete just to the lowest order (zeroth order);
the T and Q elements must be fully compatible to adjacent regular elements of the same regular order attached to their nonsingular edges;
the basis functions must model the ρ^{v-1} singular behavior of the current and charge near a sharp edge;
the basis functions must model the non singular current, normal to the edge E, which behaves as ρ^{v}.

The wedge faces in the neighborhood of the edge profile should be meshed by using three different kinds of elements:
TE edge singularity triangular elements
TV vertex singularity triangular elements and
Q singularity quadrilateral elements

TV singular vertex triangle is useful as element-filler.

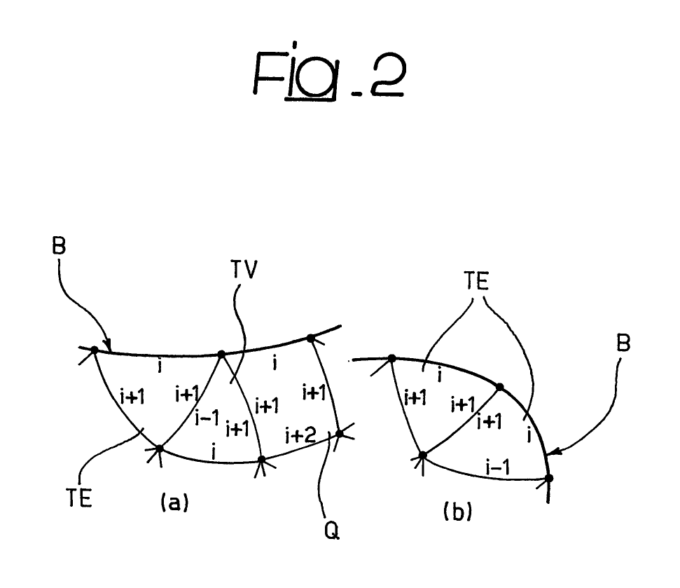

FIGS. 2a and 2b show a local edge numbering scheme used for edge singularity quadrilaterals Q and edge triangles TE, i.e. triangles with an edge departing from the edge profile B of the wedge E, and vertex singularity triangles TV.

Although two edge singularity triangles TE can have an edge in common, see FIG. 2b, the basis functions cannot model a corner 3D vertex singularity, “tip”.

Vertex singularity triangles TV are defined through the first two requirements because they are element-fillers.

The first two requirements have been introduced not to limit the mesh dimensions near the edge E, besides these requirements impose that the lowest order basis set must contain all the zeroth-order regular basis functions.

The third and the fourth requirement allow the correct physical modeling of the problem as described by Van Bladel and Meixner.

The fourth requirement can model the normal component of the current density which behaves as ρᵥ towards the edge E.

According to this process, the lowest order bases incorporating the singular behavior of the current density near the edge E of a wedge have been derived by integrating the charge density, which is already described in the cited paper by W. J. Brown and D. R. Wilton, “Singular basis functions and curvilinear triangles in the solution of the electric field integral equation,” IEEE Trans. Antennas Propagat., vol. 47, n. 2, pp. 347-353, February 1999, however the function proposed in this invention are more complete and different from the ones proposed in Wilton's and coauthor's paper. The proposed process is of additive kind, i.e. a new set of basis functions has to be added to the regular bases, unlike what Brown and Wilton proposed, where the basis functions are of non-substitutive kind, i.e. when the singularity coefficient v is set to 1 the basis functions become the regular divergence conforming bases.

According to the above properties, we propose the basis functions of table 3 for this process.
each singular basis function vanishes for v=1
the divergences of ^{e}Vᵢ(r),Vᵢ(r) basis functions model the singular distribution of the charge density that comes under the condition of zero total charge over the singular triangular element. These functions are therefore element based.

Furthermore the divergence-free current component is modeled by the following linear combination of lowest-order edge-singularity basis functions:

$${}_{}^{e}{Δ}{}_{i + 1}^{} ( r ) - {}_{}^{e}{Λ}{}_{i - 1}^{} ( r ) + {Λ}_{i + 1} ( r ) - {Λ}_{i - 1} ( r ) = \frac{{ℓ}_{i}}{𝒥} {ξ}_{i}^{v - 1} \qquad ( 11 )$$

The correct charge density is modeled by the divergence of the following combination:
^{e}Λ_{β}+Λ_{β}, for β=i±1 (12)

The ρᵥ vanishing behavior is incorporated in the element based functions. These functions have the following properties:
complete to the lowest order (the functions and their divergences);
divergence conforming;

higher order: the above scheme is defined as [p,s]=[0,0] order (the lowest order).

TABLE 3
LOWEST-ORDER DIVERGENCE-CONFORMING BASES.

| | |
|---|---|
| Basis Functions | Surface Divergences |

Triangular Bases, with subscripts counted modulo 3, and i = 1, 2 or 3

| | |
|---|---|
| Regular Functions | |
| $\begin{matrix}{Λ}_{β} ( r ) = \frac{1}{𝒥} ( {ξ}_{β + 1} {l}_{β - 1} - {ξ}_{β - 1} {l}_{β + 1} ) \\ for β = i , i \pm 1\end{matrix}$ | $\begin{matrix}∇ \cdot {Λ}_{β} ( r ) = \frac{2}{𝒥} \\ for β = i , i \pm 1\end{matrix}$ |
| Edge Singular Functions | |
| with Singularity on Edge i (ξᵢ = 0) | |
| $\begin{matrix}\begin{matrix}{}^{e} {Λ}_{i \pm 1} ( r ) = ( {ξ}_{i}^{ν - 1} - 1 ) {Λ}_{i \pm 1} ( r ) \\ {}^{e} {V}_{i} ( r ) = \frac{1}{𝒥} ( {χ}_{i + 1} {l}_{i - 1} - {χ}_{i - 1} {l}_{i + 1}\end{matrix} \\ \begin{matrix}with {χ}_{i + 1} = {{ξ}_{i} ( 1 - {ξ}_{i ∓ 1} )}^{ν - 1} - {ξ}_{i}^{ν} , \\ and {χ}_{β} = 0 at {ξ}_{β} = 0 for β = i \pm 1\end{matrix}\end{matrix}$ | $\begin{matrix}\begin{matrix}∇ \cdot {}_{}^{e}{Λ}{}_{i \pm 1}^{} ( r ) = \frac{( 1 + ν ) {ξ}_{i}^{ν - 1} - 2}{𝒥} \\ ∇ \cdot {}_{}^{e}{V}{}_{i}^{} ( r ) = - \frac{{χ}_{i + 1}^{′} + {χ}_{i - 1}^{′}}{𝒥}\end{matrix} \\ \begin{matrix}with {χ}_{i \pm 1}^{′} = \frac{{}^{d} {χ}_{i \pm 1}}{{}^{d} {ξ}_{i}} \\ = {( 1 - {ξ}_{i ∓ 1} )}^{ν - 1} - {νξ}_{i}^{ν - 1}\end{matrix}\end{matrix}$ |
| Vertex Singular Functions | |
| with Singularity on Vertex i (ξᵢ = 1) | |
| $\begin{matrix}\begin{matrix}{}^{υ} {Λ}_{i \pm 1} ( r ) = {χ}_{a} {Λ}_{i \pm 1} ( r ) - {χ}_{b} {Λ}_{i} ( r ) \\ {}^{υ} {V}_{i} ( r ) = {χ}_{a} {Λ}_{i} ( r )\end{matrix} \\ \begin{matrix}with {{χ}_{a} ( 1 - {ξ}_{i} )}^{ν - 1} - 1 \\ {χ}_{b} \frac{( 1 - ν )}{ν} {{ξ}_{i} ( 1 - {ξ}_{i} )}^{ν - 2}\end{matrix}\end{matrix}$ | $\begin{matrix}\begin{matrix}∇ \cdot {}_{}^{υ}{Λ}{}_{i \pm 1}^{} ( r ) = \frac{{χ}_{e} - 2}{𝒥} \\ ∇ \cdot {}_{}^{υ}{Λ}{}_{i}^{} ( r ) = \frac{{}^{υ} {χ}_{e} - 2}{𝒥}\end{matrix} \\ with {χ}_{e} = \frac{( 1 + ν )}{ν} {( 1 - {ξ}_{i} )}^{ν - 1}\end{matrix}$ |

Quadrilateral Bases, with subscripts counted modulo 4, and i = 1, 2, 3 or 4

| | |
|---|---|
| Regular Functions | |
| $\begin{matrix}{Λ}_{β} ( r ) = \frac{{ξ}_{β + 2} {l}_{β - 1}}{𝒥} \\ for β = i , i \pm 2 , i \pm 1\end{matrix}$ | $\begin{matrix}∇ \cdot {Λ}_{β} ( r ) = \frac{1}{𝒥} \\ for β = i , i + 2 , i \pm 1\end{matrix}$ |
| Edge Singular Functions | |
| with Singularity on Edge i (ξᵢ = 0) | |
| $\begin{matrix}{}^{e} {Λ}_{i \pm 1} ( r ) = ( {ξ}_{i}^{ν - 1} - 1 ) {Λ}_{i \pm 1} ( r ) \\ {}^{e} {V}_{i + 2} ( r ) = ( {ξ}_{i}^{ν - 1} - 1 ) {Λ}_{i \pm 2} ( r )\end{matrix}$ | $\begin{matrix}∇ \cdot {}_{}^{e}{Λ}{}_{i \pm 1}^{} ( r ) = \frac{{ξ}_{i}^{ν - 1} - 1}{𝒥} \\ ∇ \cdot {}_{}^{e}{V}{}_{i \pm 2}^{} ( r ) = \frac{{νξ}_{i}^{ν - 1} - 1}{𝒥}\end{matrix}$ |

The higher order set of functions with general order [p,s] is the following one, where the superscript [symbol] is equal to e or v for TE and TV singularity triangle, respectively:

$$\{ \begin{matrix}{}_{}^{⊲}{Λ}{}_{abc}^{i \pm 1} ( r ) = & {α}_{abc}^{i + 1} ( s , ξ ) {}_{}^{⊲}{Λ}{}_{i \pm 1}^{} ( r ) \\ {}_{}^{⊲}{Λ}{}_{abc}^{i} ( r ) = & {α}_{abc}^{i} ( s , ξ ) {}_{}^{⊲}{Λ}{}_{i}^{} ( r )\end{matrix} \qquad ( 13 )$$

number of degrees of freedom for the order [p,s]: the total number of degrees of freedom for the regular subset is (p+1)(p+3) which is added to the number of degrees of freedom of the singular subset defined previously, whose functions are independent. The total number of degrees of freedom is therefore (p+1)(p+3)+3(s+1)(s+2)/2.

The element-based function ^{e}Vᵢ₊₂(r) of quadrilateral elements Q has a vanishing normal component along each of the four element sides, and its divergence models the singular distribution of the charge density that comes under the condition of zero total charge over the singular element.

Furthermore this function models the normal component of the edge current density on edge B.

Besides the linear combination of lowest-order edge-singularity basis functions with the regular bases models the divergence-free current component parallel to the edge E and the correct charge density:

$$\begin{matrix}{}_{}^{e}{Λ}{}_{i + 1}^{} ( r ) - {}_{}^{e}{Λ}{}_{i - 1}^{} ( r ) + {Λ}_{i + 1} ( r ) - {Λ}_{i - 1} ( r ) = \frac{{ℓ}_{i}}{𝒥} {ξ}_{i}^{v - 1} & ( 14 ) \\ {}_{}^{e}{Λ}{}_{β}^{} + {Λ}_{β} , for β = i \pm 1 & ( 15 )\end{matrix}$$

These bases have the following properties:
complete to the lowest order (the functions and their divergences);
divergence conforming;
higher order: the above scheme is defined as [p,s]=[0,0] order (the lowest order).

The higher order set of functions with general order [p,s] is the following one:

$$\{ \begin{matrix}{}_{}^{ɛ}{Λ}{}_{abc}^{i \pm 1} ( r ) = & {α}_{a c ; bd}^{i + 1} ( s , ξ ) {}_{}^{ɛ}{Λ}{}_{i \pm 1}^{} ( r ) \\ {}_{}^{ɛ}{Λ}{}_{a c ; bd}^{i + 2} ( r ) = & {α}_{a c ; bd}^{i + 2} ( s , ξ ) {}_{}^{ɛ}{V}{}_{i + 2}^{} ( r )\end{matrix} \qquad ( 16 )$$

number of degrees of freedom for the order [p,s]: the total number of degrees of freedom for the regular subset is 2(p+1)(p+2) which is added to the number of degrees of freedom of the singular subset defined previously, whose functions are independent by discarding, for example, all the functions
   ^{e}Λ_{ac;bd}ⁱ⁻¹(r)d={1,s}; a,b,c={1,s+1} (17)

The total number of degrees of freedom is then (p+1)(p+3)+3(s+1)(s+2)/2.

The benefits of using higher order singular vector bases are illustrated by showing Finite Element results for cylindrical homogeneous waveguides. The problem is formulated in terms of the electric field as in P. Savi, I. L. Gheorma, and R. D. Graglia, “Full-wave high-order FEM model for lossy anisotropic waveguides,” IEEE Trans. Microwave Theory Tech., Vol. 50, No. 2, pp. 495-500, February 2002. The Galerkin form of the finite-element method is used to reduce the transverse vector Helmholtz problem into a generalized eigenvalue problem solved by use of an iterative method. A C++ object-oriented code computes the modal longitudinal wavenumbers kz at a given frequency f as well as the modal fields. A symbolic representation of the singular FEM integrals is implemented to integrate the singular functions by adding up analytic integral results. This technique is highly effective and does not require complex programming to provide integral results to machine precision.

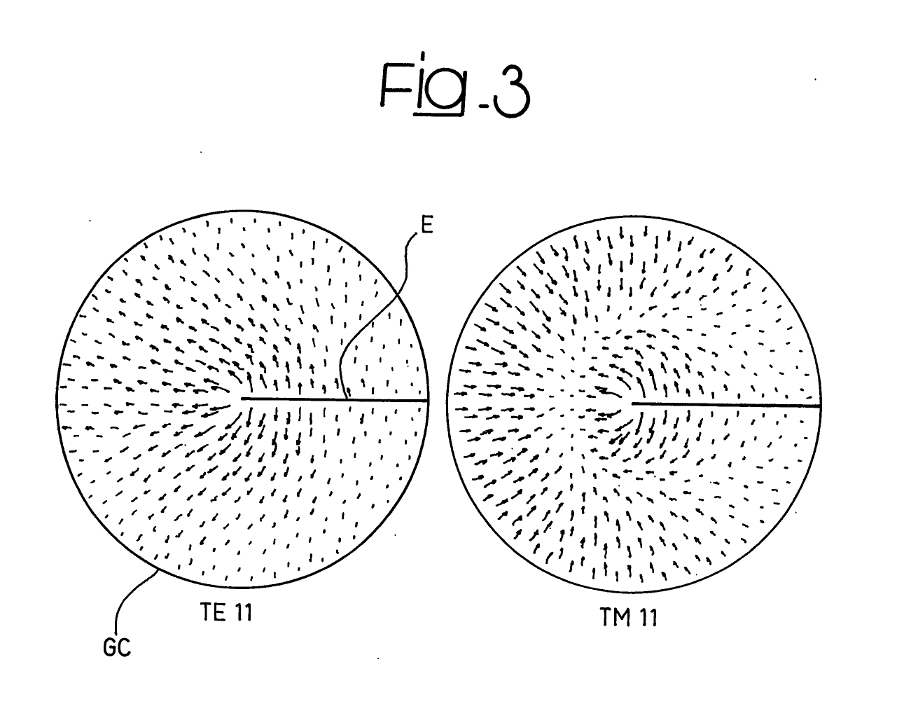

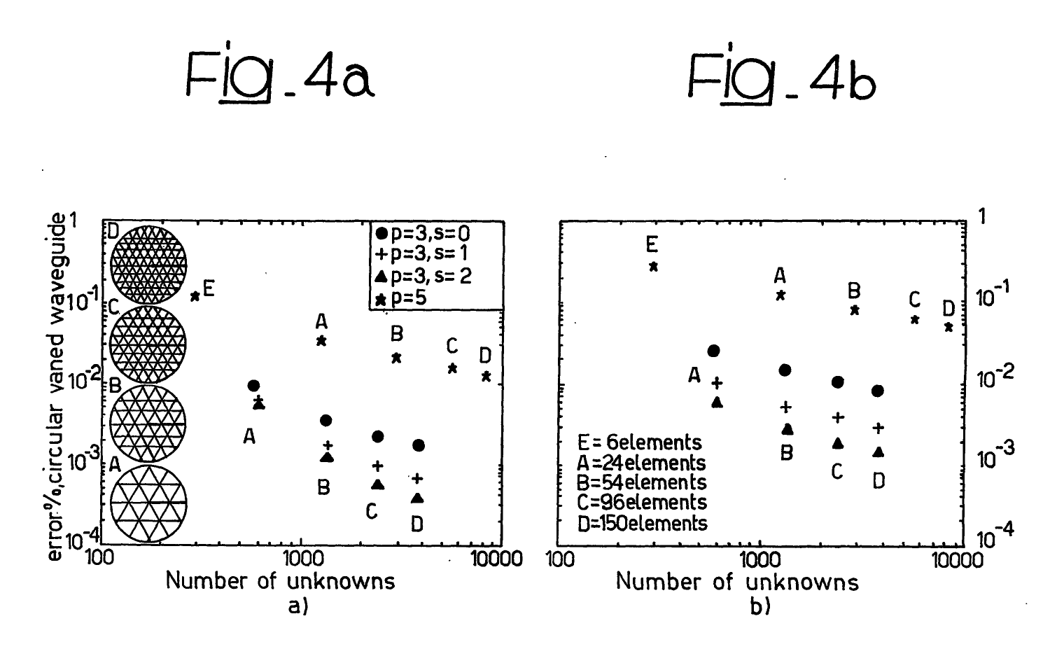

The first test case is a circular perfect conducting waveguide GC, of radius a, filled by homogeneous material, as reported in FIG. 3, with a singular region E constituted by a zero thickness radial vane extending to its center. The normalized waveguide dimension is (ko·a), where ko is the free-space wavenumber. The zeroes of the Bessel functions Jm/2 of half-integer order, and of the derivatives of these Bessel functions yield the TM and TE eigenvalues respectively. The first subscript labeling these modes is m; the second subscript n indicates the order of the zero, as usual. Even values of m correspond to modes supported also by a circular waveguide, although the vane suppresses all the TM0n circular waveguide modes. The modal fields exhibiting a v=½ singularity at the edge of the vane are those of the TE1n and the TM1n modes, and the singular TE11 mode is dominant. The numerically obtained transverse electric field topographies of the first two singular modes are reported in FIG. 3. FIG. 4 reports the percentage error in the computed square values kzˆ₂ of the longitudinal wavenumbers versus the number of unknowns. In FIG. 4a the error is averaged over the first twenty modes, which involve four singular modes.

FIG. 4b shows the error averaged over the first four singular modes. These results have been obtained by using five different meshes. Meshes from A to D are show in FIG. 4a (24, 56, 96, 150 elements). Mesh E (not shown) consists of only six curved triangular elements having as a common vertex the sharp-edge vertex. Notice that all the used meshes have six triangular elements attached to the sharp-edge vertex. FIG. 4 show the effects obtained by trying bases of different singular s-order only on these six sharp-edge elements. The increase of degrees of freedom, DOFs, is related to the singularity order s and is relatively small with respect to improvements on the numerical result precision. In fact the results of FIG. 4, although obtained by using fifth-order regular elements, are always worse than the results provided by using singular elements.

FIG. 5 shows the normalized matrix fill-in time of the FEM matrix versus the number of extra DOF's required to study the problems of FIG. 4 with singular elements and for p=3. These results show that the technique used to integrate the singular functions has usually no-impact on the cpu-time required to fill-in the FEM matrices, unless singular elements are a good percentage of the all elements.

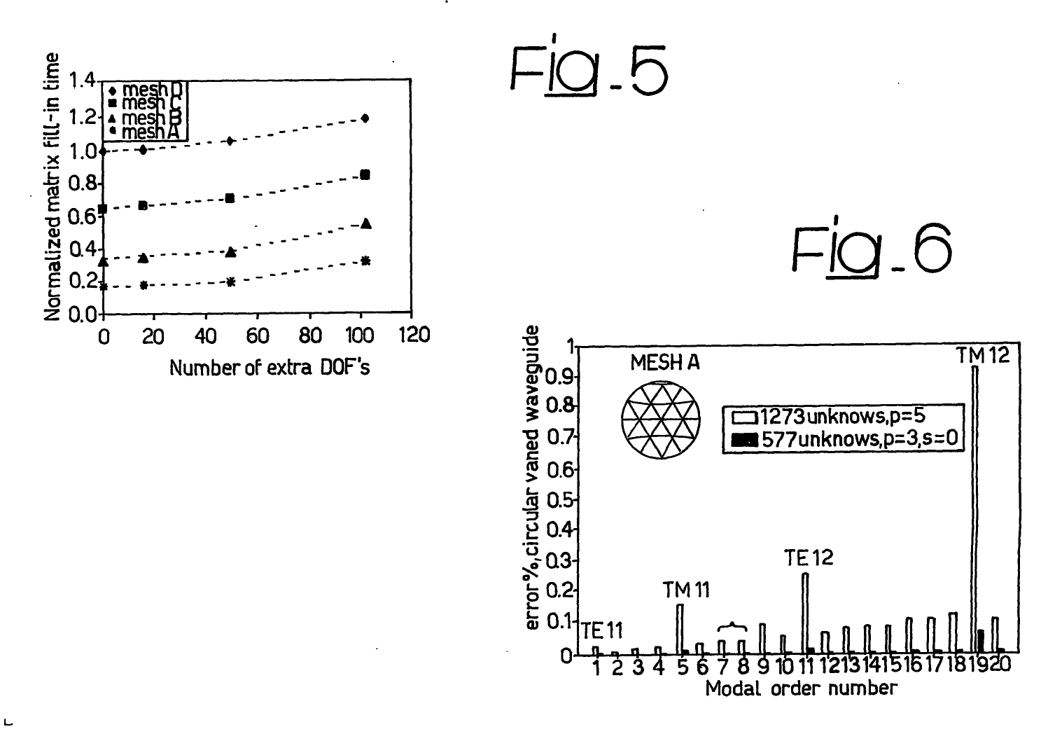

Singular elements provide a noticeable improvement also in the regular mode results, since any lack of precision in the coefficients of the stiffness matrix yields to errors on all modes. For example, FIG. 6 reports the A-mesh percentage error in the computed square value kzˆ2 of the longitudinal wavenumber for each of the first twenty modes of the circular vaned waveguide GC.

In FIG. 5 the times are normalized with respect to the cpu-time tD spent by our sparse-solver in filling-in the D-mesh FEM matrices by using only regular elements of order p=3. Our object-oriented code yields 65.6 seconds on a Pentium IV Xeon@2.4 GHz machine. The number of extra DOF's is zero for the regular p=3 cases that correspond to 3741, 2369, 1309, 561 DOF's for mesh D, C, B and A, respectively. For all the used meshes, the number of extra DOF's is 16, 50 and 102 for s=0, 1 and 2, respectively.

FIG. 6 shows the percentage error in the computed square value of the longitudinal wavenumber (zˆ2) for each of the first twenty modes of the circular vaned waveguide at ko·a=11 and the modes expressly labeled in the figure exhibit a singular field at the edge of the vane. Mode 7 and 8 has the same cutoff frequency since they correspond to the TM11 and the TE01 modes of the circular waveguide.

The second problem we consider is a circular waveguide GC2 of radius a with two radial vanes, labeled ER, of thickness equal to a/50 facing each other along a diameter. The vane separation gap is centered and its width is again a/50. The singularity coefficient for this case is v=⅔. Although analytical results for this waveguide are not available, we studied it to show the ability of our singular bases to handle cases where sharp-edge elements of a given wedge are bordered by sharp edge elements of a different wedge, and also to prove the effectiveness of singular elements in dealing with thick layers.

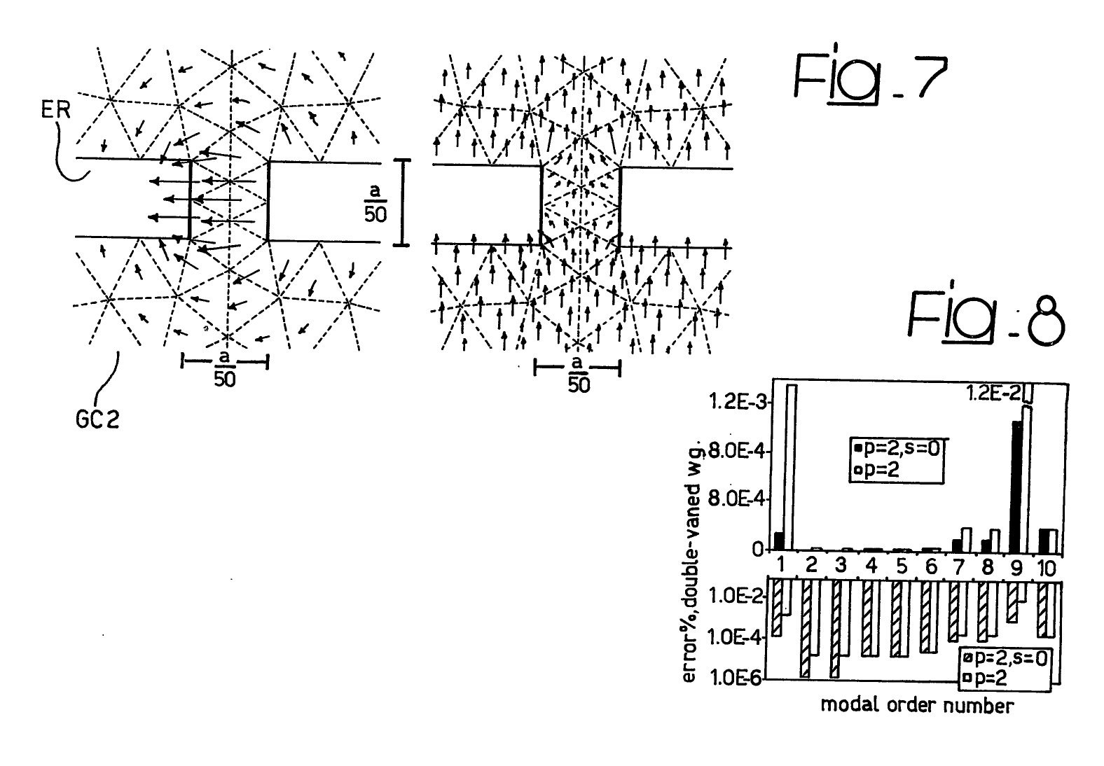

FIG. 7 shows in the near-gap region both the used mesh and the numerically obtained transverse electric field topographies of the first two modes supported by the GC2 waveguide with double septum of radius a. The field topography of the dominant mode is reported on the left side. The mesh is constituted by 374 triangles and it is quite dense in the gap region where there are 16 sharp-edge elements. Other settings are ko·a=11 and p=2, s=0 (5459 unknowns).

FIG. 8 shows the percentage error in the computed square value of the longitudinal wavenumber (kzˆ₂) for each of the first ten modes of the circular double-vaned waveguide GC2 with double septum at ko·a=11. Errors are reported in natural scale at top and in logarithmic scale at bottom. In this case, only 40 extra DOF's are required to switch regular (p=2) elements to (s=0) singular order elements. The (p=2) regular case corresponds to 5419 DOF's.

The second mode of this waveguide is very similar to the dominant TE11 mode of the circular waveguide, with distorted field topography only in the gap region. Conversely, all the energy of the dominant mode of the double-vaned waveguide is concentrated in the gap region so that it turns out that the dominant mode is quasi-TEM.

The percentage error in the computed square value kzˆ₂ of the longitudinal wavenumber for each of the first ten modes of the circular double-vaned waveguide is reported in FIG. 8 in natural as well as in logarithmic scale. The errors have been computed by choosing as a reference the values obtained by running the code with p=3, s=2 (9733 unknowns). Once again, one notices that regular bases yield higher errors than singular bases.

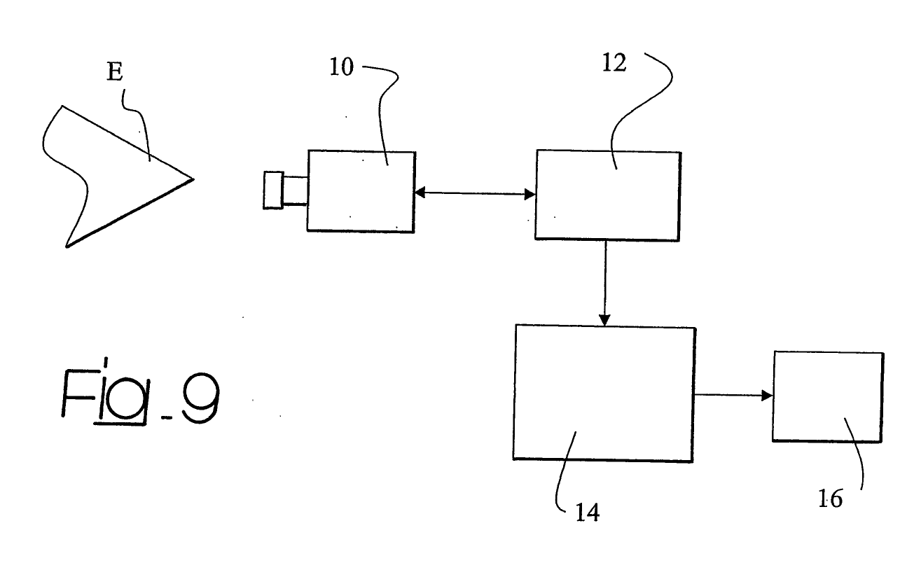

FIG. 9 shows the control unit of a system which implements the modeling process according to the invention.

In this system the geometry of the edge E for a general body is obtained by a scan module 10, which produces a surface map that is transmitted to analogic-digital converter 12.

According to the specific application requirements, the scan module 10 can be, for example, a TV camera, a photo camera or a surface scanning machine.

The analogic-digital converter 12 converts the surface map to numeric data which are transmitted to a processor 14 that implements the modeling process described previously for the analysis and design of the structure.

In particular the edge E can belong to any open or closed structure analyzable with FEM and MoM techniques constituted by different materials. Processor 14 processes the field/current components, which are supplied to a system 16.

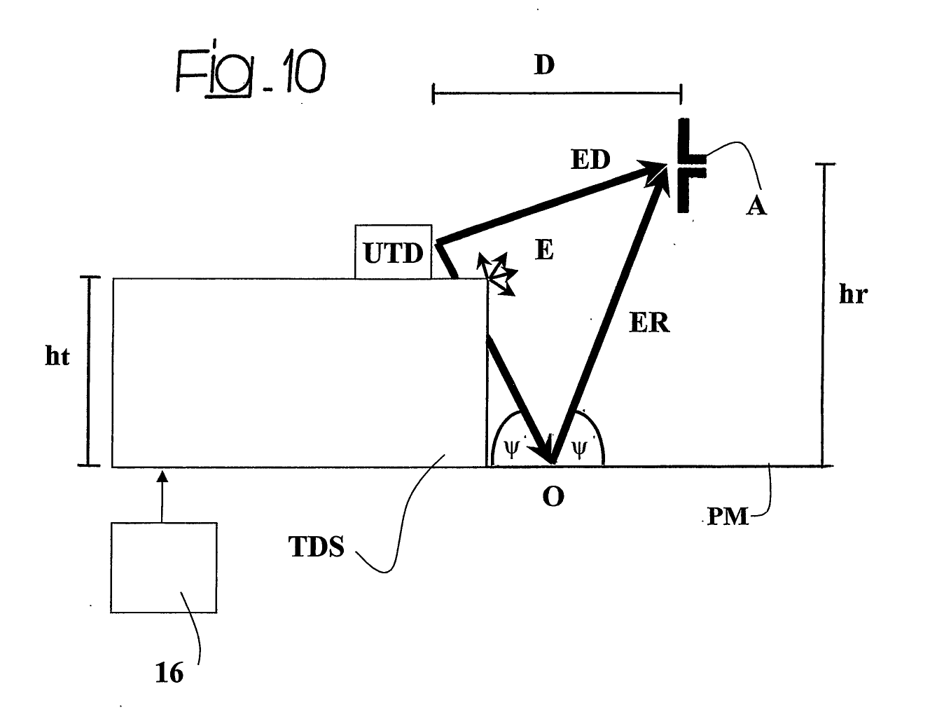

As example of the system reported in FIG. 9, FIG. 10 shows a measure system to test the Radiated Emission from a device, labeled UTD, on the ground plane. The UTD device is set on a dielectric table TDS, being at h from the ground plane PM. An antenna A receives the direct-link electromagnetic wave ED and a reflected wave ER, which is incident on the ground plane PM at point O with an angle ψ. The UTD device is at the distance D from the receiving antenna A, which is at hr height with respect to the ground plane PM. The international normatives, as for example the FCC (Federal Communications Commission) require measures with prefixed values of the distance D and heights ht and hr, and the use of correction factors in order to consider the reflected wave ER, correlated to the possible different wave polarizations (horizontal or vertical), but these processes do not provide any optimal position for the UTD device on the dielectric table TDS.

Unfortunately the diffractive contributions of the table's edges E are considerable. With reference to the control unit of the system implementing the proposed modeling process, the edge E corresponds to the edge E of FIG. 9. In this system, the geometry of table's edge E is scanned by the geometry scan module 10, which produces a surface map transmitted to the analogic-digital converter 12. According to the specific application requirements, the scan module 10 can be, for example, a TV camera, a photo camera or a touching machine. The analogic-digital converter 12 converts the surface map to numeric data which are transmitted to a processor 14 that implements the modeling process described previously for the analysis and design of the structure. Processor 14 processes the fields/currents components, and supplies them to the system 16 which controls the position of the table TDS in order to minimize the effects of the edge E, or in order to determine a correction factor for the edge E effects.

The use of a scanning system is useful for radar applications, analysis of prototypes and final products: radar systems, loss analysis, material properties . . . On the other hand CAD softwares could be used for the analysis and design of structures instead of a scanning module.

The above solution allows great improvements with respect to the known solutions.

The proposed process, which defines subsectional vector basis functions of polynomial kind together with subsectional vector basis function of singular kind of arbitrary order, permit one to advantageously obtain the correct solution even if the singularities are not excited, and without limiting the size of the elements (small number of elements of large dimensions).

Furthermore advantageously, the properties of subsectional singular (non polynomial) basis subsets agree with the physics of the problem. We have proposed a process to define basis functions useful to obtain the numerical solution of problems described by partial differential equations and integral equations.

Furthermore advantageously, in relation to the proposed process basis functions can be easily defined for finite methods, for example the Finite Element Method (FEM) and the Method of Moments (MOM) for applied electromagnetics.

Of course, it is understood that the principles of this invention, the productive details and the productive options can be widely changed with respect to what described and presented here, without digressing from this invention, as described in the enclosed claims.

1. A process for numerically modelling singular vector physical quantities associated to at least a body (E), with possible local singular behavior of the physical quantities that may assume unlimited values in the singularity region; the process is characterized by the following operations:
to scan (10) the geometry of the singularity region and to plot it with a reference frame;
to subdivide the singularity region into two dimensional domains; and
to describe with reference to these domains the properties of at least a physical quantity directly in the parent domain, deriving the singular curl conforming basis functions and the singular divergence conforming basis functions for domains meshed with (r, TE, TV) triangles and (Q) quadrilaterals.

2. Process as defined in claim 1, characterized by the fact that at least one of the two-dimensional elements, T, TE, TV triangular elements and Q quadrilateral elements, is curvilinear.

3. Process as defined in claim 1 or claim 2, characterized by the operation that defines systematically higher order potentials to determine the static component of the curl conforming singular bases.

4. Process as defined at least in one or more claims from 1 to 3, characterized by the operation that defines higher order edge-less basis functions to model the dynamic component of the above curl conforming singular basis functions.

5. Process as defined in claim 1, characterized by the operation that defines singular divergence conforming basis functions of different kind if the element T is an “element-filler”.

6. Process as defined at least in one or more claims from 1 to 5, characterized by the operation that defines the lowest number of curl conforming basis functions and divergence conforming basis functions to model the singular behavior and to evaluate the number of degrees of freedom in relation with the selected order of the bases.

7. Process as defined at least in one or more claims from 1 to 5, characterized by the operation that implements singular bases in Finite Element Method (FEM) codes and Method of Moments codes.

8. Process as defined at least in one or more claims of claim 1, 2, 3, 4, 6 or 7, characterized by the fact that in the Finite Element Method framework the singular basis functions are complete to the lowest order and satisfies the following requirements:
the basis functions and their curls are complete to the lowest order (zeroth order);
the meshed domain (T,Q) is fully compatible with the regular elements of the same regular order which are adjacent to the nonsingular edge or edges;
these functions are suitable for modeling the ρ^{v-1} static singular behavior.
these functions are suitable for modeling the nonsingular behavior field with curl that vanishes as ρ^{v} towards the singularity region.

9. Process as defined at least in one or more claims of claim 1, 2, 3, 4, 6, 7 or 8, characterized by the fact that defines a set of singular potential functions in order to model the static singular component of the transverse fields near the singularity region (E) by deriving singular vector bases from the gradient of the potential functions.

10. Process as defined at least in one or more claims of claim 1, 2, 3, 4, 6, 7, 8 or 9, characterized by the fact that these potential functions satisfies the following requirements:
they vanish when the singularity coefficient v is equal to 1
they are identically equal to zero on all the element edges i, except for one attached to the sharp-edge (E), this requirement guarantees that the gradient is normal to the edges where the potential is zero
the potentials are constructed so to guarantee the correct singular tangent component of their gradient along the edge where the potential is not zero.

11. Process as defined at least in one or more claims of claim 1, 2, 3, 5, 6, 7, or 8, characterized by the fact that it is necessary to define in the singularity region a set of vector basis functions to model the curl behavior of the field near the singularity (dynamic component).

12. Process as defined at least in one or more claims of claim 1, 2, 5, 6 or 7, characterized by the fact that in the Method of Moments framework where the basis functions model singular current densities, the singular basis functions contains a singular divergence conforming subset which satisfies completely the following requirements:
the basis functions and their divergences are complete to the lowest order (zeroth order);
the meshed domain (T,Q) is fully compatible with the regular elements of the same regular order which are adjacent to the nonsingular edge or edges;
these functions are suitable for modeling the ρ^{v-1} singular behavior of currents and charge near the singularity region (E).
these functions are suitable for modeling the nonsingular behavior of the current which is normal to the singularity region (E) and vanishes as ρ^{v}.

13. Control unit of a system (16) containing: one geometry scan module (10) for a singularity region (E) of a body; this module is suitable to produce a surface map of the body (E), one numeric conversion module (12) of the map, one processor (14) to elaborate the map after the numeric conversion has been made and to control a system (16) that uses the elaborated data, characterized by the fact that the processor (14) is set to implement the numerical modeling process according to the claim from 1 to 12.

14. System as defined in claim 13, characterized by the fact that the singularity region (E) belongs to a positioning instrument (TDS) for a device under test (UTD) and that this positioning instrument (TDS) is controlled by the control unit (16).

15. Software product, loadable into the memory of a computer, and containing routines to implement the process as for claims from 1 to 12 when the product is run by a computer.
